(19) United States
(12) Patent Application Publication
(10) Pub. No.: US 2009/0016051 A1
(43) Pub. Date: Jan. 15, 2009

(54) LIGHT EMITTING DEVICE DIFFUSERS FOR GENERAL APPLICATION LIGHTING

(75) Inventor: Robert L. Wood, Cary, NC (US)

Correspondence Address: MYERS BIGEL SIBLEY & SAJOVEC, PO BOX 37428, RALEIGH, NC, 27627, US

(73) Assignee: Bright View Technologies, Inc.

(21) Appl. No.: 12/109,685

(22) Filed: Apr. 25, 2008

Related U.S. Application Data
(60) Provisional application No. 60/913,904, filed on Apr. 25, 2007.

(51) Int. Cl. F21V 1/00; F21V 11/00

(52) U.S. Cl. 362/235; 362/355

(57) ABSTRACT

An LED diffuser may provide a more deterministic distribution of light from multiple discrete sources without relying on statistical scattering, and therefore, may reduce the type of efficiency losses associated with conventional diffusers as noted above. For example, an LED diffuser may have a smooth external surface that can be both aesthetically pleasing and easily cleanable. In still other embodiments according to the invention, an LED diffuser can include a single multilayer film. Further, an LED diffuser can include a plurality of multi-layer films that can provide additive diffusion properties. An LED diffuser can also be provided as a component of an LED light fixture.

### CROSS REFERENCE TO RELATED APPLICATION

This application claims priority to U.S. Provisional Patent Application No. 60/913,904, filed on Apr. 25, 2007, the disclosure of which is hereby incorporated herein by reference in its entirety.

### FIELD OF THE INVENTION

The present invention relates to the field of lighting, and more particularly, to diffusers for lighting.

### BACKGROUND

Compared with incandescent lighting, light emitting diodes (LEDs) can provide much longer life, higher efficiency, and/or greater control of spectral output. One challenge faced in LED lighting stems from the need to combine multiple separate LEDs in a single fixture to produce light equivalent to a single incandescent bulb. For example, an LED light fixture may include more than six separate LEDs to equal the output of a single conventional light bulb. For aesthetic reasons, lighting producers may want to produce LED light fixtures that resemble traditional lighting fixtures as closely as possible. Moreover, since the LEDs within a light fixture may generate different color spectra light, it may be desirable to combine the colors generated by the separate LEDs to produce a single aesthetically pleasing color.

A conventional light fixture may be equipped with a diffuser to help spread light in a desirable pattern and/or to “soften” the look of the light. Diffusers can also help reduce “glare” or light output that may otherwise be directed at eye level. Examples of typical diffusers include lampshades, fluorescent fixture lens sheets, and the frosted inner surface of conventional incandescent bulbs. While these examples may be effective for conventional light sources, they can fall short in certain aspects when used with LED light fixtures. For example, many conventional diffusers may not obscure multiple point sources of light. Thus, when placed in close proximity to an array of LEDs, a typical lighting diffuser may allow an observer to discern the separate light sources even though the light from the separate LEDs may be at least partially blended. This may produce an undesirable visual effect.

Furthermore, conventional light diffusers may lack the ability to efficiently blend the different colors generated the separate LEDs. A light fixture that produces multiple colors may lack aesthetic appeal.

Many conventional diffusers, filled plastics or etched glass surfaces, provide diffusion properties through statistical scattering of light. Diffusers based on statistical scattering may suffer loss in efficiency as their diffusion properties are increased. This is due to multiple forward scattering or backscattering that can result in light being absorbed or redirected along undesirable pathways. This inverse relationship between diffusion and efficiency can reduce or prevent the efficient use of conventional diffusers in LED lighting.

Light diffusers are also discussed in, for example, the following U.S. Pat. Nos.: Re. 33,593; 3,829,677; 4,006,355; 4,388,675; and 4,703,405.

### SUMMARY

Embodiments according to the invention can provide light emitting device diffusers for general application lighting. Pursuant to these embodiments according to the invention, an LED diffuser can include first and second facing microstructures each having respective major axes oriented in different directions and separated by a layer having a different refractive index than that of the first and second facing microstructures.

In some embodiments according to the invention, an LED diffuser can include an array of first microstructures, where the first microstructures have a first index of refraction and define first concave openings in a surface of the array and are oriented with a major axis thereof in a first direction. An array of second microstructures have the first index of refraction and define second concave openings that face the first concave openings and are oriented with a major axis thereof orthogonal to the first direction. A layer between the array of first microstructures and the array of second microstructures has a second index of refraction that is less than the first index of refraction.

In some embodiments according to the invention, an LED diffuser can include a first diffuser layer that includes first and second arrays of facing microstructures, where the microstructures have respective major axes oriented in different directions. Further the first and second arrays are separated by a first layer having a lower refractive index than that of the microstructures. A second diffuser layer includes first and second arrays of facing microstructures, where the microstructures have respective major axes oriented in different directions. The first and second arrays are separated by a second layer having the lower refractive index and a pressure sensitive adhesive is located between the first and second diffuser layers.

In some embodiments according to the invention, an LED diffuser can include at least two arrays of facing microstructures separated by a lower refractive index layer, where the diffuser is configured to provide step-indexing via the at least two arrays and the layer for refraction of incoming light.

### BRIEF DESCRIPTION OF THE FIGURES

FIG. 1 is a cross-sectional view of a single layer light emitting device diffuser in some embodiments according to the invention,

FIG. 2 is a cross-sectional view of a multi-layer light emitting device diffuser in some embodiments according to the invention.

FIG. 3 is a schematic diagram that illustrates LED light fixtures including diffusers in some embodiments according to the invention.

### DESCRIPTION OF EMBODIMENTS ACCORDING TO THE INVENTION

The invention is described hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. In the drawings, the thickness of layers and regions are exaggerated for clarity. Like numbers refer to like elements throughout. As used herein the term “and/or” includes any and all combinations of one or more of the associated listed items and may be abbreviated as “/”.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, regions, steps, operations, elements, and/or components, but do not preclude the presence or addition of one or more other features, regions, steps, operations, elements, components, and/or groups thereof.

It will be understood that when an element such as a layer or region is referred to as being “on” or extending “onto” another element, it can be directly on or extend directly onto the other element or intervening elements may also be present. In contrast, when an element is referred to as being “directly on” or extending “directly onto” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

It will be understood that, although the terms first, second, etc. may be used herein to describe various elements, components, regions, layers and/or sections, these elements, materials, regions, layers and/or sections should not be limited by these terms. These terms are only used to distinguish one element, material, region, layer or section from another element, material, region, layer or section. Thus, a first element, material, region, layer or section discussed below could be termed a second element, material, region, layer or section without departing from the teachings of the present invention.

Furthermore, relative terms, such as “lower”, “base”, or “horizontal”, and “upper”, “top”, “vertical”, or “downstream” may be used herein to describe one element's relationship to another element as illustrated in the Figures. It will be understood that relative terms are intended to encompass different orientations of the device in addition to the orientation depicted in the Figures. For example, if the device in the Figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. Moreover, sharp angles that are illustrated, typically, may be rounded. Thus, the regions illustrated in the figures are schematic in nature and their shapes are not intended to illustrate the precise shape of a region and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Unless otherwise explicitly defined, as used herein below, the abbreviation “LED” refers to a light emitting device, such as a light emitting diode. However, it will be understood that embodiments according to the invention are not limited to light emitting diodes, but can be used with any light emitting device.

LED diffuser embodiments according to embodiments of the invention may combine improved light diffusion properties, source obscuration, color mixing, and/or increased efficiency compared to conventional diffusers. In some embodiments according to the invention, an LED diffuser may provide a more deterministic distribution of light from multiple discrete sources without relying on statistical scattering, and therefore, may reduce the type of efficiency losses associated with conventional diffusers as noted above. In other embodiments according to the invention, an LED diffuser may have a smooth external surface that can be both aesthetically pleasing and easily cleanable. In still other embodiments according to the invention, an LED diffuser can include a single multilayer film. In other embodiments according to the invention, an LED diffuser can include a plurality of multi-layer films that can provide additive diffusion properties. In still other embodiments according to the invention, an LED diffuser can be provided as a component of an LED light fixture.

As described herein, in some embodiments according to the invention, light from the LEDs is primarily refracted rather than scattered (as is done by the conventional art). In particular, embodiments according to the invention can include an arrangement of microstructures having a step-index layering structure, where the separate layers provide refraction of the light provided by the LED sources. These structures can provide unexpected high efficiency in light transmission, allowing design of diffusers with very high obscuration and light distribution, and/or a pleasing appearance.

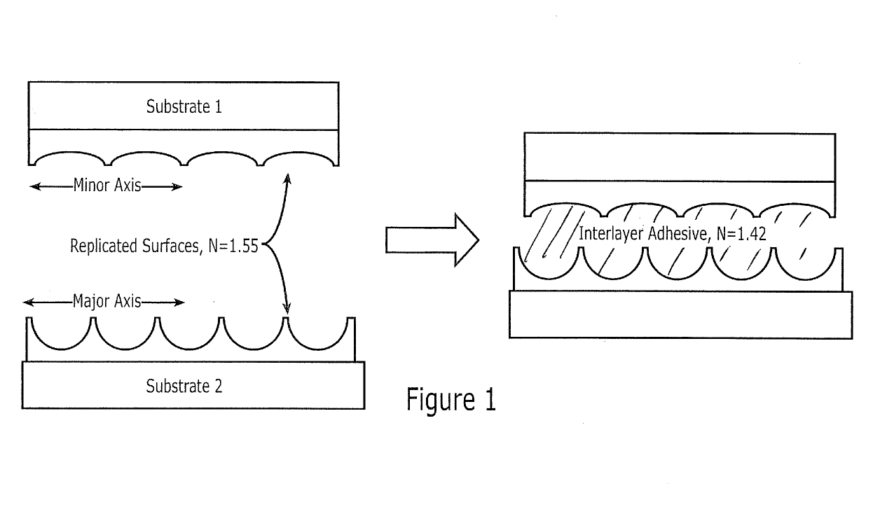

FIG. 1 is a cross-sectional view of a single layer LED diffuser in some embodiments according to the invention. In particular, two arrays of microstructures face one-another and are separated by a layer having a different (e.g., lower) refractive index than the arrays. As shown in FIG. 1, concave openings of the microstructures included in the first and second arrays face one another, with an interlayer therebetween. The resulting diffuser can have a relatively symmetric light diffusion pattern and the texture of the upper and lower surfaces can be smoother than conventional diffusers.

Referring to FIG. 1, a lighting diffuser sheet was fabricated by laminating together two sheets of 7 mil thick polyester film having microreplicated structures on their surface. Microstructures were produced through a photoreplication process. See, for example, U.S. Pat. No. 7,902,166 to Wood, entitled Microlens Sheets Having Multiple Interspersed Anamorphic Microlens Arrays, which is currently commonly assigned to the present assignee. In particular, the polyester film included a photopolymer with refractive index of about 1.55. The two sheets were laminated using an interlayer of silicone-based coating having a cured refractive index of about 1.42. The microstructures formed were concave lens-like structures distributed in an array on the surface. The individual concave lens-like structures were about 70 microns in width and formed concave depressions about 40 um in depth.

The shape of the microstructures was as disclosed in U.S. Pat. No. 7,092,166 to Wood, although other shapes can be used according to embodiments of the invention. As described therein, this type of lens array may have one axis that causes a larger degree of light divergence in one axis (termed the major axis), and a lesser degree of divergence in a second axis (the minor axis). In diffusers produced according to this example, the major light divergence axis of the first sheet was oriented at a right angle to the major divergence angle of the second sheet. Both the first and second sheets had minor axes of divergence that were orthogonal to their major axes of divergence. Thus in the laminated structure the minor axes were also at right angles to one another. The diffuser thus produced showed a symmetric, square light diffusion pattern enclosed in a cone angle of +/−30° and having smooth upper and lower surfaces. When installed in an LED light fixture containing multiple LED sources of differing color, the light exiting the diffuser had a pleasing white color, and obscured the individual light sources. Measurement of light output with and without the diffuser installed showed a transmission efficiency of 94.5%.

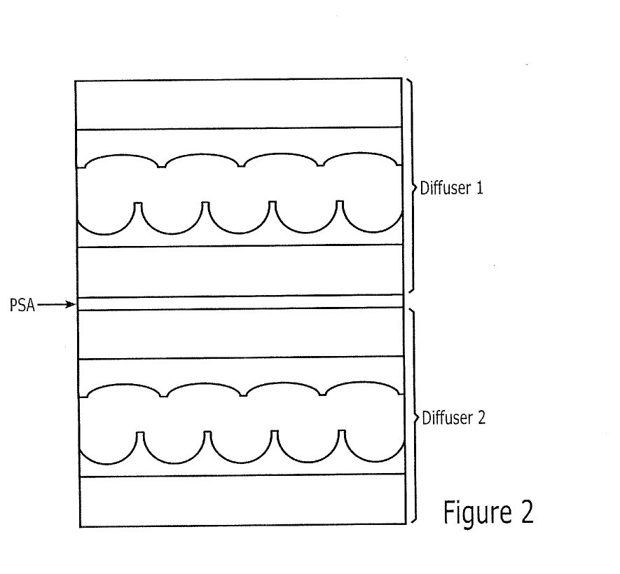

FIG. 2 is a cross-sectional view of a multilayer LED diffuser in some embodiments according to the invention. As shown in FIG. 2, two diffusers of the arrangement shown in FIG. 1 were laminated together using a pressure-sensitive adhesive (PSA). The resulting diffuser had a symmetric light diffusion pattern enclosed in a cone of +/−60°, and had smooth upper and lower surfaces.

It will be understood that embodiments according to the present invention can include more than two layers of the of the microreplicated structures shown in FIGS. 1 and 2. Furthermore, although some embodiments are described herein as including arrays of microstructures having respective major (and minor) axes that are orthogonal to one another, it will be understood that other orientations can be used. It will be further understood that, in some embodiments according to the invention, the shapes of the microstructures can be defined by parametric models, such as those described in U.S. Pat. No. 7,092,166 to Wood. Furthermore, the microstructures included in each of the arrays may be different from one another, so that the array may include microstructures defined according to different parametric models. It will be further understood that the parametric models can provide for the anamorphic shapes of the microstructures, which defines the orientation of the major and minor axes of the microstructures.

It will further be understood that, in some embodiments according to the invention, the same parametric model can be used to define the anamorphic shapes of the first and second arrays. However, the orientation of the microstructures into two different arrays can be offset one another. For example, in some embodiments according to the invention, the microstructures in the first array are defined using a parametric model so that the respective major axis lies in a first direction and a minor axis lies in the second, orthogonal, direction. The same parametric model can be used to define the microstructures included in the second array where the respective major axis in the second array is offset from the major axis in the first array by 90°. Furthermore, the minor axis in the first array is also offset from the minor axis of the second array by 90°.

In still other embodiments according to the invention, a single substrate having an array of microstructures formed thereon can provide a diffuser (i.e., without the formation of a facing second array of microstructures). In other embodiments according to the invention, the single substrate described above can be provided with the adhesive layer shown in FIG. 1 (again without the second array of microstructures).

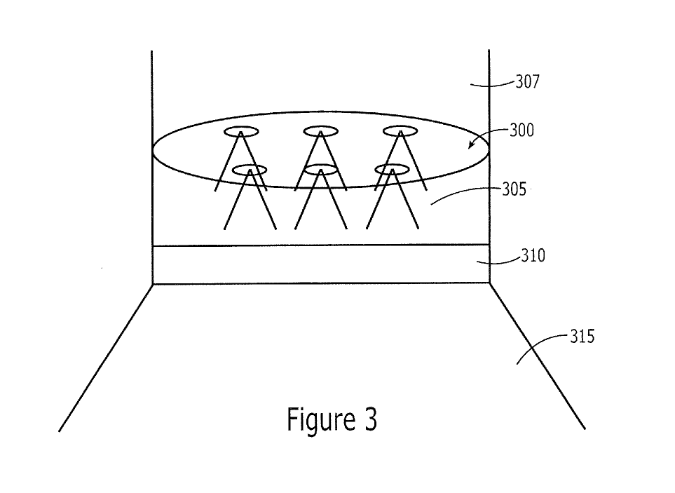

FIG. 3 is a diagram that illustrates LED lighting fixtures in some embodiments according to the invention. As shown in FIG. 3, diffuser 310 described herein can be combined with a multiple source LEDs 300 (mounted in a housing 307) so that the diffuser 310 is “downstream” from separated light 305 generated by the multiple source LEDs 300 to provide a more uniform light 315 to a space. It will be understood, however, that the diffuser may be provided separately from other parts of the LED lighting fixture. For example, the multiple source LED may be provided by a fixture manufacturer, whereas the diffuser may be provided by another party. It will further be understood that, although embodiments according to the invention described herein in reference to light emitting diodes, the diffusers according to the present invention can be used with any multiple light source fixture.

Many alterations and modifications may be made by those having ordinary skill in the art, given the benefit of present disclosure, without departing from the spirit and scope of the invention. Therefore, it must be understood that the illustrated embodiments have been set forth only for the purposes of example, and that it should not be taken as limiting the invention as defined by the following claims. The following claims are, therefore, to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

What is claimed:

1. A Light Emitting Device (LED) diffuser comprising:
first and second facing microstructures each having respective major axes oriented in different directions and separated by a layer having a different refractive index than that of the first and second facing microstructures.

2. A diffuser according to claim 1 wherein the first and second facing microstructures are included in respective first and second facing arrays.

3. A diffuser according to claim 1 wherein refractive indices for the first and second facing microstructures are about equal.

4. A diffuser according to claim 3 wherein the refractive indices for the first and second facing microstructures are about equal.

5. A diffuser according to claim 4 wherein the refractive indices for the first and second facing microstructures are about 1.55 and the lower refractive index of the layer separating the first and second facing microstructures is about 1.42.

6. A diffuser according to claim 1 wherein the major axes are oriented orthogonal to one another.

7. A diffuser according to claim 1 wherein the first and second facing microstructures are defined according to respective first and second parametric models to provide first and second anamorphic shapes to the first and second facing microstructures.

8. A diffuser according to claim 7 wherein the first and second parametric models are the same or different.

9. A diffuser according to claim 1 wherein the first and second facing microstructures define respective facing concave openings.

10. A diffuser according to claim 1 wherein the first and second facing microstructures further comprise respective minor axes oriented in different directions.

11. A Light Emitting Device (LED) diffuser comprising:
an array of first microstructures, wherein the first microstructures have a first index of refraction and define first concave openings in a surface of the array and are oriented with a major axis thereof in a first direction;
an array of second microstructures, wherein the second microstructures have the first index of refraction and define second concave openings that face the first concave openings and are oriented with a major axis thereof orthogonal to the first direction; and
a layer between the array of first microstructures and the array of second microstructures, wherein the layer has a second index of refraction that is less than the first index of refraction.

12. A diffuser according to claim 11 wherein the first index of refraction is about 1.55 and second index of refraction is about 1.42.

13. A diffuser according to claim 1 wherein the first and second microstructures are defined according to respective first and second parametric models to provide first and second anamorphic shapes.

14. A diffuser according to claim 13 wherein the first and second parametric models are the same or different.

15. A light emitting diode lighting fixture comprising:
a plurality of light emitting diodes configured to provide light from the light emitting diode fixture to a space;
a diffuser, configured downstream from the light from the plurality of light emitting diodes, the diffuser comprising
first and second facing microstructures each having respective major axes oriented in different directions and separated by a layer having a lower refractive index than that of the first and second facing microstructures.

16. A Light Emitting Device (LED) diffuser comprising:
first and second facing microstructures each having respective major axes oriented in different directions and separated by a layer having a lower refractive index than that of the first and second facing microstructures.

17. A Light Emitting Device (LED) diffuser comprising:
a first diffuser layer including first and second arrays of facing microstructures the microstructures having respective major axes oriented in different directions, the first and second arrays being separated by a first layer having a lower refractive index than that of the microstructures; and
a second diffuser layer including first and second arrays of facing microstructures the microstructures having respective major axes oriented in different directions, the first and second arrays being separated by a second layer having the lower refractive index; and
a pressure sensitive adhesive between the first and second diffuser layers.

18. A Light Emitting Device (LED) diffuser comprising:
at least two arrays of facing microstructures separated by a lower refractive index layer, the diffuser configured to provide step-indexing via the at least two arrays and the layer for refraction of incoming light.
